(19) United States
(12) Patent Application Publication
(10) Pub. No.: US 2017/0288193 A1
(43) Pub. Date: Oct. 5, 2017

(54) LITHIUM SECONDARY BATTERY AND METHOD OF MANUFACTURING THE SAME

(71) Applicant: Hyundai Motor Company, Seoul (KR)

(72) Inventors: Shin Kook Kong, Seoul (KR); Sang Mok Park, Seongnam (KR); Sung Hoon Lim, Gunpo (KR); Sang Heon Lee, Yongin (KR); Dong Hui Kim, Suwon (KR)

(21) Appl. No.: 15/248,020

(22) Filed: Aug. 26, 2016

(30) Foreign Application Priority Data
Apr. 5, 2016 (KR) 10-2016-0041629

(51) Int. Cl. H01M 2/16; H01M 10/058; H01M 10/0562; H01M 10/0565; H01M 10/0525

(52) U.S. Cl. CPC H01M 2/1673; H01M 10/0565; H01M 10/0525; H01M 10/0562; H01M 10/058; H01M 2220/20

(57) ABSTRACT

Disclosed is a lithium secondary battery including: a positive electrode current collector comprising a positive electrode material mixture; a negative electrode current collector comprising of a negative electrode material mixture and laminated on the positive electrode current collector; a separator disposed between the positive electrode current collector and the negative electrode current collector; and a composite conductive material coated on the separator which faces the positive electrode current collector.

### CROSS-REFERENCE TO RELATED APPLICATION

This application claims the benefit of priority to Korean Patent Application No. 10-2016-0041629, filed on Apr. 5, 2016 in the Korean Intellectual Property Office, the disclosure of which is incorporated herein in its entirety by reference.

### TECHNICAL FIELD

The present invention relates to a lithium secondary battery and a method of manufacturing the same. The lithium secondary battery may have an improved output and stability in addition to improved battery capacity.

### BACKGROUND OF THE INVENTION

In general, a lithium secondary battery has a structure in which lithium electrolyte is impregnated in an electrode assembly, which is composed of a positive electrode including a lithium transition metal oxide as an electrode active material, a negative electrode including a carbon-based active material, and a separator.

The lithium secondary battery includes a non-aqueous composition. For example, the electrode is generally manufactured by coating electrode slurry on a current collector, and the electrode slurry is manufactured by mixing an electrode material mixture, which includes an electrode active material for storing energy, a conductive material for providing an electrical conductivity, and a binder for bonding them to the current collector and providing a binding force between them with a solvent such as N-methyl pyrrolidone (NMP). Generally, a copper foil, an aluminum foil, and the like have been used as a current collector of secondary battery.

However, in a compression process during the manufacture of electrode or in the next manufacturing process, adhesive strength between the electrode material mixture and the current collector may be reduced to generate dust, and the electrode active material attached to a surface may be delaminated during operation of the battery. The decrease of the adhesive strength and the delamination of the active material may significantly decrease the battery performance, for example, may reduce output characteristic by increasing an internal resistance of the battery and may cause a decrease of battery capacity.

Thus, various methods for solving these problems have been proposed in the related arts. For example, a method of increasing the bond strength for the current collector by etching the surface of aluminum current collector to form fine irregularities has been reported. This method may obtain the aluminum current collector of a high specific surface area through a simple process, however, may have a problem of decreasing the life of the aluminum current collector due to the etching process.

One of the most major causes of causing delamination of the positive electrode active material in the positive electrode using a low cost aluminum current collector may be that a fluorine source of the electrolyte reacts with the aluminum of the current collector in an operating voltage of the positive electrode to form a film such as aluminum monofluoride (AlF) on surface thereof. The AlF film formation may be further accelerated due to the increase of the source of fluorine during the increase of battery temperature. The AlF film may reduce the adhesive strength between the positive electrode active material and the aluminum current collector thereby to increase the resistance of the positive electrode. Thus, delamination of the positive electrode active material may occur, and electrical characteristic of the battery may be degraded, in particular, by reducing the moving speed of electrons from the positive electrode active material to the current collector, thereby affecting the performance of the battery.

A chemical cell includes a positive electrode (anode), a negative electrode (cathode), a separator for separating the positive electrode and the negative electrode, and an electrolyte. The electrolyte may eliminate polarization that may occur during electrochemical reaction by promoting the movement of charge. The cell using lithium as a negative electrode is generally referred to as a lithium battery.

For the lithium battery, in order to ensure safety by a function such as the prevention of a spread of internal short, even in the case of a high-capacity, the positive electrode material mixture, the negative electrode material mixture, the separator, or the like may be coated with a ceramic which is insulated or has no electric conductivity, in order to improve safety.

### SUMMARY OF THE INVENTION

In preferred aspects, the present invention provides a lithium secondary battery that may maintain an energy density (the amount of energy per weight) or a battery capacity by complementing a penetration characteristic in a battery for vehicle. Such a battery for the vehicle may often require an operation or a high output when a certain energy or more is supplied, without increasing the amount of energy per weight in order to ensure safety by an insulating layer.

In one aspect, a lithium secondary battery may include: a positive electrode current collector comprising a positive electrode material mixture; a negative electrode current collector comprising a negative electrode material mixture and laminated on the positive electrode current collector; a separator disposed between the positive electrode current collector and the negative electrode current collector; and a composite conductive material coated on the separator which faces the positive electrode current collector.

The composite conductive material may include: a conductive material; and a binder coating the composite conductive material on the separator.

Preferably, the conductive material may be injected into the binder and then be agitated. The conductive material may be uniformly injected into the binder after agitation.

A slurry may be coated on the positive electrode current collector and the negative electrode current collector, and the slurry may include: a negative electrode slurry provided to the negative electrode current collector; and a positive electrode slurry provided to the positive electrode current collector while being in surface-contact with the composite conductive material.

The binder suitably may be a jelly type, and suitably be bonded by hot rolling. The binder may be one selected from the group consisting of graphene, acetylene black, carbon black, vapor-grown carbon fiber (VGCF), and combinations thereof. The binder may comprise polyurethane and polyvinylidene difluoride (PVDF).

In another aspect, a method of manufacturing a lithium secondary battery may include: mixing a binder and a solvent; injecting a conductive material to the binder to form a composite conductive material; and coating the composite conductive material on a first surface of a separator. The composite conductive material may be agitated or uniformly mixed before the coating process.

After coating agitated composite conductive material on one surface (e.g. the first or the second surface) of a separator, the method further includes: laminating a positive electrode current collector and a negative electrode current collector, disposing the separator between the positive electrode current collector and the negative electrode current collector, and disposing the composite conductive material to face the positive electrode current collector.

Coating the agitated composite conductive material on the surface of a separator may include drying the composite conductive material.

Further provided is a vehicle that may comprise the lithium secondary batter as described herein.

According to various exemplary embodiments, the lithium secondary battery and the method of manufacturing the same may provide the following advantages.

First, when coating conductive material on the surface of the separator while facing the positive electrode current collector, electric conductivity of the surface of the positive electrode current collector may be increased, as consequence, output characteristic may be improved at a room temperature or a low temperature.

Second, a layer having an excellent conductivity may be in contact with the surface of the positive electrode to improve a heat radiation characteristic, and stability such as penetration may be improved, and fine short may be early implemented by heat dissipation even in extreme circumstance thereby preventing any issue in the battery.

Third, a complex layer including the conductive material and the binder may be coated on the separator to induce to an early short mode and diffuse heat fast and stably.

Fourth, since a slurry of conductive material is bonded to the positive electrode current collector by a kind of binder, the reaction between the electrodes and the separator interface may be inhibited to prevent oxidation and the like. In addition, precipitation of salt due to a gap may not occur between the electrode and the separator and be efficiently prevented thereby improving a battery life.

Fifth, a composite conductive material layer may be coated on the separator to reduce processing cost.

Sixth, as the composite conductive material is provided to the separator, the loading level, the density of material mixture, the thickness of electrode, the porosity, and the like may be simplified during the cell design, so that cell may have various designs.

### BRIEF DESCRIPTION OF THE DRAWINGS

The objects, features and advantages of the present invention will be more apparent from the following detailed description in conjunction with the accompanying drawings, in which:

FIG. 1 illustrates an exemplary cell of an exemplary lithium secondary battery according to an exemplary embodiment of the present invention;

FIG. 2 illustrates an exemplary lithium secondary battery according to an exemplary embodiment of the present invention;

FIG. 3 illustrates an exemplary separator according to an exemplary embodiment of the present invention.

### DETAILED DESCRIPTION OF EXEMPLARY EMBODIMENTS

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

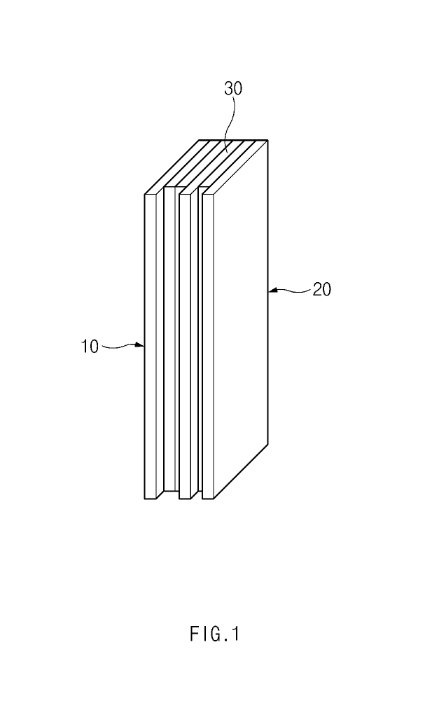

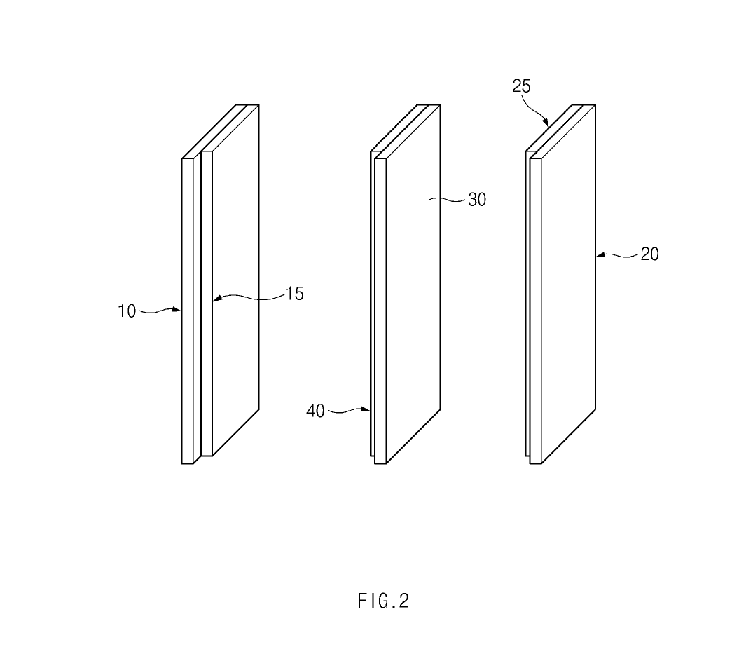

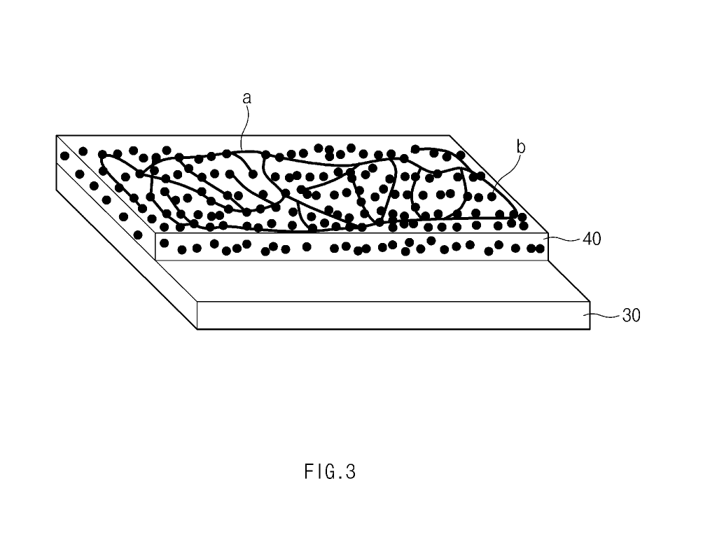

FIG. 1 illustrates an exemplary cell of an exemplary lithium secondary battery according to an exemplary embodiment of the present invention, FIG. 2 illustrates an exemplary lithium secondary battery, and FIG. 3 illustrates an exemplary separator.

According to an exemplary embodiment, an electrode according to the present invention features a stable bond between an electrode material mixture and a current collector and furthermore may minimize a binder contained in the electrode material mixture and conductive material inputs, such that a high capacity and high output secondary battery may be provided.

A negative electrode of the present invention may use, as a negative electrode active material. The negative electrode active material may include carbon and graphite material, for example, suitably may include one or more selected from the group consisting of natural graphite, artificial graphite, expanded graphite, carbon fiber, non-graphitizable carbon, carbon black, carbon nanotube, fullerene, and activated carbon. The negative electrode active material may include metal which may be selected from the group consisting of Al, Si, Sn, Ag, Bi, Mg, Zn, In, Ge, Pb, Pd, Pt, Ti, alloys thereof with lithium, and combinations thereof. The negative electrode active material suitably may include the metal compound and carbon such as graphite material-complex, or nitrides containing lithium.

However, the negative electrode active material may not be particularly limited, but preferably, the negative electrode active material may be a single element or a combination of two or more elements selected from a group consisting of crystalline carbon, amorphous carbon, silicon-based active materials, tin-based active material, and silicon-carbon-based active material. Further, it may include general binder contained in the negative electrode, conductive material, and other additives. The above negative electrode active materials may be added in an amount as generally accepted in the related.

The lithium secondary battery of the present invention may have a structure in which non-aqueous electrolyte may be impregnated in an electrode assembly having a structure in which a separator may be interposed between the positive electrode and the negative electrode.

The separator may be interposed between the positive electrode and the negative electrode, and may include an insulating thin film having high ion permeability and mechanical strength. A pore diameter of the separator may range from about 0.01 to about 10 μm, and a thickness may range from about 5 to about 300 μm.

As the separator, for example, an olefin-based polymer such as a chemically resistant and hydrophobic polypropylene; a sheet or nonwoven fabric formed of glass fiber or polyethylene and the like; a kraft paper and the like may be used.

Commercially available typical example may be cell guard series (Celgard™ 2400, 2300 (Hoechest Celanese Corp. product), a polypropylene separator (Ube Industries Ltd. product, or Pall RAI Co. product) and polyethylene series (Tonen or Entek), and the like.

On the other hand, gel polymer electrolyte may be coated on the separator in order to increase the stability of the battery. Typical example of the gel polymer may be polyethylene oxide, polyvinylidene fluoride, polyacrylonitrile, and the like. When a solid electrolyte such as a polymer may be used as the electrolyte, the solid electrolyte may also serve as the separator.

A detailed example of the positive electrode active material of the present invention may include, for example, a layered compound, such as example, lithium cobalt oxide (LiCoO₂), lithium nickel oxide (LiNiO₂) and the like, or compound substituted with one or more transition metal; lithium manganese oxide such as chemical formula Li₁₊ₓMn₂₋ₓO₄ (where, x ranges from 0 to 0.33), LiMnO₃, LiMn₂O₃, LiMnO₂; lithium copper oxide (Li₂CuO₂); vanadium oxide such as LiV₃O₈, LiFe₃O₄, V₂O₅, Cu₂V₂O₇ and the like; Ni cite type lithium nickel oxide represented by chemical formula LiNi₁₋ₓO₂ (where, M=Co, and Mn, Al, Cu, Fe, Mg, B or Ga, x=0.01-0.3); lithium manganese composite oxide represented by chemical formula LiMn₂₋ₓMₓO₂ (where, M=Co, Ni, Fe, Cr, Zn or Ta, x=0.01-0.1) or Li₂Mn₃MO₈ (where, M=Fe, Co, Ni, Cu or Zn); LiMn₂O₄ where part of Li of chemical formula is substituted with alkaline earth metal ion; disulfide compounds; Fe₂(MoO₄)₃; Li(NixCOyMnz)O₂, where x+y+z=1, and the like.

However, it is not limited thereto. Preferably, the positive electrode active material may include one selected from the group consisting of lithium cobalt oxide, lithium manganese oxide, lithium nickel oxide, lithium manganese-cobalt-nickel oxide, and combinations thereof.

A current collector may be at least one current collector of a positive electrode and a negative electrode, but preferably, may be a positive electrode current collector. The current collector may be a region where electrons move through an electrochemical reaction of the active material. The material of the current collector may not be limited as long as the material has conductivity while not causing a chemical change to a corresponding battery. Preferably, the material of the current collector may include copper, stainless steel, aluminum, nickel, titanium, and/or baked carbon, or may be a material which may be surface-treated with carbon, nickel, titanium, silver on the surface of copper, aluminum, or stainless steel, or may be aluminum-cadmium alloy.

Meanwhile, a metal layer coated on the positive electrode current collector has a structure in which a reactor capable of forming a self-assembled monolayer may be exposed to the outside of a metal particle. When processing a current collector metal by a solution obtained by dispersing a metal particle containing a reactor capable of forming a self-assembled monolayer in water, or an organic solvent, a self-assembled monolayer may be formed in an entire or part of the current collector, and an electrode material mixture may be coated on the self-assembled monolayer.

The solvent for forming a self-assembled monolayer containing metal may be, preferably, one selected from the group consisting of distilled water, ethanol, acetonitrile, and acetone, and, preferably, may be manufactured as aqueous solution by using distilled water.

The self-assembled monolayer containing a metal in the current collector according to an exemplary embodiment of the present invention may not necessarily be formed on the entire surface of the current collector but may be coated on the entire or portion of the surface of the current collector. The area of the self-assembled monolayer may be suitably adjusted within a range to improve an adhesive strength with the electrode material mixture and an electrical conductivity. However, when the thickness of the self-assembled monolayer containing a metal is less than the predetermined range, for example, equal to or more than 1 um, the electrical conductivity may be improved, however, for that case, when the length of the organic substances is less than the predetermined range, for example, equal to or more than 1 um, self-assembled monolayer may not be sufficiently formed. Therefore, it is preferable to properly adjust the thickness of the self-assembled monolayer.

The positive electrode material mixture may contain the positive electrode active material, the conductive material, and the binder, and may selectively further include other components such as a viscosity adjusting agent, a filler, a crosslinking promoter, a coupling agent, an adhesion promoter and the like.

The lithium secondary battery may have a structure in which non-aqueous electrolyte containing lithium salt may be impregnated in the electrode assembly having a structure where a separator may be interposed between the positive electrode and the negative electrode. The separator may be interposed between the positive electrode and the negative electrode, and may use an insulating thin film having high ion permeability and mechanical strength. A pore size of the separator may generally range from about 0.01 to about 10 μm, and the thickness may generally range from about 5 to about 300 μm. For example, the separator 30 may use a sheet or nonwoven fabric kraft paper formed of olefin-based polymer glass fiber such as a chemically resistant and hydrophobic polypropylene or a polyethylene and the like.

It is appreciated that the cell guard series (e.g. Celgard™ 2400, 2300, Hoechest Celanese Corp. product, a polypropylene separator (Ube Industries Ltd. product, or Pall RAI Co. product) and polyethylene series (Tonen or Entek), and the like may be provided for suitable separators of the present invention.

Meanwhile, a gel polymer electrolyte may be coated on the separator 30 in order to increase the stability of the battery. Typical example of the gel polymer may be, without limitation, polyethylene oxide, polyvinylidene fluoride, polyacrylonitrile, and the like. When a solid electrolyte such as a polymer is employed as the electrolyte, the solid electrolyte may also serve as the separator.

The non-aqueous electrolyte containing lithium salt may be formed of a non-aqueous electrolyte and a lithium salt. A non-aqueous electrolytic solution, solid electrolyte, inorganic solid electrolyte, and the like may be used as the non-aqueous electrolyte.

For example, the non-aqueous electrolytic solution may include an aprotic organic solvent such as N-methyl-2-pyrrolidinone, propylene carbonate, ethylene carbonate, butylene carbonate, dimethyl carbonate, diethyl carbonate, ethylmethyl carbonate, gamma-butyro lactone, 1,2-dimethoxy ethane, 1,2-diethoxy ethane, tetrahydroxy franc, 2-methyl tetrahydrofuran, dimethylsulfoxide, 1,3-dioxolane, 4-methyl 1,3-oksen, diethylether, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, ethyl propionate, and the like.

Binder may be a component of supporting the combination between the active material and the conductive material and the combination to the current collector, and usually may be added in an amount of about 1 to 50 weight % based on the total weight of electrode material mixture. Examples of the binder may include polyvinylidene fluoride (PVDF), polyvinyl alcohol, carboxymethyl cellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber, fluoro rubber, and various copolymers thereof.

Meanwhile, the binder may be provided by any one of polyurethane and polyvinylidene difluoride (PVDF).

Here, the conductive material may be one selected from the group consisting of graphene, acetylene black, carbon black, vapor-grown carbon fiber (VGCF), or combinations thereof. Here, the conductive material (b) may be provided by the same material as the binder (a), but different types of binder (a), such as water-based or oil-based solvent, may suitably be used.

The conductive material may be a component for further improving the conductivity of electrode active material, and may be added in an amount of about 1 to 20 weight % based on the total weight of the electrode material mixture. This conductive material may not be particularly limited and any material having conductivity but not causing a chemical change to a corresponding battery, may use the conductive material. For example, the conductive material may include graphite such as natural graphite or artificial graphite, and the like; carbon black such as carbon black, acetylene black, Ketjen black, channel black, furnace black, lamp black, summer black, and the like; conductive fiber such as carbon fiber or metallic fiber; metallic powder such as carbon fluoride, aluminum, nickel powder, and the like; conductive whiskers such as zinc oxide and potassium titanate; conductive metal oxide such as titanium oxide; phenylene derivative, and the like.

A preferred lithium secondary battery of vehicle may be changed by a person of ordinary skill in the art and, in the various exemplary embodiments, without limitations.

FIG. 1 shows an exemplary cell of an exemplary lithium secondary battery according to an exemplary embodiment of the present invention, FIG. 2 shows an exemplary lithium secondary battery, and FIG. 3 shows v separator, according to the exemplary embodiments of the present invention.

As shown in to FIG. 1 to FIG. 3, the lithium secondary battery of the present invention may include: (1) a positive electrode current collector 10 comprising a positive electrode material mixture, (2) a negative electrode current collector 20 comprising a negative electrode material mixture and laminated on the positive electrode current collector 10, (3) a separator 30 disposed between the positive electrode current collector 10 and the negative electrode current collector 20, and a composite conductive material 40 comprising a conductive material and coated on the separator 30 which faces the positive electrode current collector 10. A slurry 15, 25 may be coated on the positive electrode current collector 10 and the negative electrode current collector 20.

A positive electrode slurry 15 may be coated on the positive electrode current collector 10. Meanwhile, a negative electrode slurry 25 may be coated on the negative electrode current collector 20. That is, the slurry 15, 25 may be arranged in such a manner that the negative electrode slurry 25 is provided to the negative electrode current collector 20 and the positive electrode slurry 15 is provided to the positive electrode current collector 10 which faces the negative electrode slurry 25 as being in surface-contacting with the composite conductive material 40.

The composite conductive material 40 may be provided with a conductive material, and may be coated on one surface of the separator 30 facing the positive electrode current collector 10. The composite conductive material 40 may include a conductive material (b) having conductivity, and a binder (a) coating the composite conductive material 40 on the separator 30.

The separator 30 may be coated with the composite conductive material 40 and may be disposed between the positive electrode current collector 10 and the negative electrode current collector 20. The separator 30 may be formed to have substantially uniform surface than the positive electrode current collector 10 and the negative electrode current collector 20.

The binder (a) may be a jelly type, and may be bonded by hot rolling. The binder (a) may be included in the composite conductive material 40 at the same mass as the conductive material (b).

In this case, by inputting the conductive material (b) into the binder (a) to perform agitation, the composite conductive material 40 comprising the conductive material to implement a desired viscosity, a binder, a water may be coated on the separator 30 by using a coating equipment at a predetermined thickness and amount according to user's intention. At this time, the coated materials may be dried to remove the water or a solvent. Since the next process can be performed by a person of ordinary skill in the art, a description is omitted.

The operation of the lithium secondary battery according to the above embodiment of the present invention is described.

As shown in FIG. 1 to FIG. 3, the first, the binder in an amount of about 8% is mixed with water 92%, based on the total weight of the mixture. Agitation may be performed through a binder solution mixer (not shown) to form a binder solution, preferably, for at least 2 hours.

Next, the composite conductive material 40 may be formed by injecting the conductive material having the same mass as the binder solution to the binder. In this case, the composite conductive material 40 may be agitated by a mixer having a strong torque such as a bead mill mixer. However, it is not limited thereto, and any apparatus having a sufficient torque for agitation is enough.

Thereafter, the agitated composite conductive material may be coated on a surface (e.g. a first surface or a second surface) of the separator 30. The thickness and amount of the coating may be optionally adjusted. Then, the coated composite conductive material may be dried to remove water or the like.

Next, the positive electrode current collector 10 and the negative electrode current collector 20 may be provided. A slurry 15, 25 may be disposed at the positive electrode current collector 10 and the negative electrode current collector 20 in a direction of facing each other. Then, the separator 30 may be disposed between the positive electrode current collector 10 and the negative electrode current collector 20. The composite conductive material 40 of the separator 30 may be disposed to face the positive electrode current collector 10. Since next process is the same as a general LIB manufacturing process, a description is omitted.

Accordingly, when coating the conductive material on the surface of the separator to face the positive electrode current collector, the electric conductivity of the surface of the positive electrode current collector may be increased, so that output characteristic may be improved in a room temperature and low temperature.

Further, a layer having an excellent conductivity may be in contact with the surface of the positive electrode to improve a heat radiation characteristic, and stability such as penetration may be improved, and fine short may be early implemented by heat dissipation even in extreme circumstance, and issue is not generated in the battery.

Since a slurry of conductive material is bonded to the positive electrode current collector by a kind of binder, the reaction between the electrodes and the separator interface may be inhibited to prevent oxidation and the like. In addition, since an error, such as precipitation of salt due to a gap between the electrode and the separator, may be prevented to improve a battery life.

In addition, a complex layer of the kind of the conductive material and the kind of binder may be coated on the separator to induce to an early short mode and diffuse heat fast and stably, and a composite conductive material layer may be coated on the separator to reduce processing cost, and as the composite conductive material is provided to the separator, the loading level, the density of material mixture, the thickness of electrode, the porosity, and the like may not be considered complexly during the cell design, so that cell may have various designs.

Hereinabove, although the present invention has been described with reference to exemplary embodiments and the accompanying drawings, the present invention is not limited thereto, but may be variously modified and altered by those skilled in the art to which the present disclosure pertains without departing from the spirit and scope of the present disclosure claimed in the following claims.

What is claimed is:

1. A lithium secondary battery comprising:
a positive electrode current collector comprising a positive electrode material mixture;
a negative electrode current collector comprising a negative electrode material mixture, is the negative electrode current collector laminated on the positive electrode current collector;
a separator disposed between the positive electrode current collector and the negative electrode current collector; and
a composite conductive material coated on the separator which faces the positive electrode current collector.

2. The lithium secondary battery of claim 1, wherein the composite conductive material comprises:
a conductive material; and
a binder coating the composite conductive material on the separator,
wherein the composite conductive material is formed by injecting conductive material into the binder and agitating thereof.

3. The lithium secondary battery of claim 2, wherein a slurry is coated on the positive electrode current collector and the negative electrode current collector, and
the slurry comprises:
a negative electrode slurry provided to the negative electrode current collector; and
a positive electrode slurry provided to the positive electrode current collector while being in surface-contact with the composite conductive material.

4. The lithium secondary battery of claim 2, wherein the binder is a jelly type, and bonded by hot rolling.

5. The lithium secondary battery of claim 2, wherein the binder is selected from the group consisting of graphene, acetylene black, carbon black, vapor-grown carbon fiber (VGCF), and combinations thereof.

6. The lithium secondary battery of claim 2, wherein the binder comprises polyurethane and polyvinylidene difluoride (PVDF).

7. A method of manufacturing a lithium secondary battery, the method comprising:
mixing a binder and a solvent;
forming a composite conductive material by injecting a conductive material to the binder and agitating the injected conductive material and the binder; and
coating the agitated composite conductive material on a surface of a separator.

8. The method of claim 7, further comprising after coating agitated composite conductive material on one surface of a separator:
laminating a positive electrode current collector and a negative electrode current collector,
disposing the separator between the positive electrode current collector and the negative electrode current collector, and
disposing the composite conductive material to face the positive electrode current collector.

9. The method of claim 7, wherein the coated composite conductive material on the surface of a separator is dried to remove a moisture of the composite conductive material.

10. A vehicle comprising a lithium secondary battery of claim 1.
